(19) United States
(12) Patent Application Publication
(10) Pub. No.: US 2008/0017198 A1
(43) Pub. Date: Jan. 24, 2008

(54) AEROSOL DELIVERY APPARATUS AND METHOD FOR PRESSURE-ASSISTED BREATHING SYSTEMS

(75) Inventor: Ehud Ivri, Newport Beach, CA (US)

Correspondence Address: TOWNSEND AND TOWNSEND AND CREW LLP, TWO EMBARCADERO CENTER, EIGHTH FLOOR, SAN FRANCISCO, CA, 94111, US

(73) Assignee: Aerogen, Inc., Mountain View, CA (US)

(21) Appl. No.: 11/834,531

(22) Filed: Aug. 6, 2007

Related U.S. Application Data
(63) Continuation of application No. 10/957,321, filed on Sep. 30, 2004, now Pat. No. 7,267,121.
Application No. 10/957,321 is a continuation-in-part of application No. 10/828,765, filed on Apr. 20, 2004.

(51) Int. Cl. A62B 7/00

(52) U.S. Cl. 128/204.21; 128/204.18

(57) ABSTRACT

A pressure-assisted breathing system is provided that comprises: a pressure-generating circuit for maintaining a positive pressure within the system; a patient interface device coupled to a patient's respiratory system; a respiratory circuit for providing gas communication between the pressure-generating circuit and the patient interface device; means for introducing aerosol particles into the gas flow in the respiratory circuit; and means for discontinuing the introduction of aerosol particles into said respiratory circuit gas flow when the patient exhales. In one embodiment, a flow sensor is disposed in an auxiliary circuit in fluid communication with the respiratory circuit and electronically coupled with a nebulizer. The flow sensor is adapted to detect changes in the volumetric flow rate of gas in the auxiliary circuit when the patient exhales and stops exhaling and sends corresponding electronic signals to the nebulizer to turn off and turn on, respectively.

### CROSS-REFERENCES TO RELATED APPLICATIONS

This application is a continuation-in-part of U.S. application Ser. No. 10/828,765, filed Apr. 20, 2004, and is related to U.S. application Ser. No. 10/883,115, filed Jun. 30, 2004, both of which are incorporated by reference herein in their entirety.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

This invention relates to apparatus and methods for delivering medication to the respiratory system of a patient, preferably an infant, through a pressure-assisted breathing system. More specifically, one aspect of the invention is directed to apparatus and methods for coupling a flow sensor with a continuous positive airway pressure (“CPAP”) system that employs a nebulizer, preferably one having a vibrating aperture-type aerosol generator, to deliver aerosolized medicament simultaneously with CPAP treatment.

The use of CPAP systems and therapies are conventional forms of ventilation treatment for respiratory disorders in both adults and children. In particular, it has been reported that respiratory support with nasal CPAP (“NCPAP”), coupled with simultaneous treatment with nebulized drugs, preferably surfactants, has several advantages in the treatment of infant respiratory distress syndrome (“iRDS”) in pre-term infants (“neonates”). For example, early application of NCPAP and early treatment with aerosolized surfactant in neonates with iRDS have been found to be effective in decreasing the need for mechanical ventilation, with its accompanying mechanical and infectious risks and pathophysiological effects. See, for example, “To the Editor: Surfactant Aerosol Treatment of Respiratory Distress Syndrome in Spontaneously Breathing Premature Infants”; Pediatric Pulmonology 24:22-224 (1997); “Early Use of Surfactant, NCPAP Improves Outcomes in Infant Respiratory Distress Syndrome”; Pediatrics 2004; 11; e560-e563 (as reported online by Medscape Medical News group, Jun. 4, 2004); and “Nebulization of Drugs in a Nasal CPAP System”; Acta Paediatr 88: 89-92 (1999).

CPAP systems utilize a constant positive pressure during inhalation to increase and maintain lung volumes and to decrease the work by a patient during spontaneous breathing. The positive pressure effectively dilates the airway and prevents its collapse. The delivery of positive airway pressure is accomplished through the use of a positive air flow source (“flow generator”) that provides oxygen or a gas containing oxygen through a flexible tube connected to a patient interface device such as nasal prongs (cannula), nasopharyngeal tubes or prongs, an endotracheal tube, mask, etc. CPAP systems typically maintain and control continuous positive airway pressure by using a restrictive air outlet device, e.g. a fixed orifice or threshold resistor, or a pressure valve, which modulates the amount of gas leaving the circuit to which the patient interface device is attached. This pressure regulating device may be placed at, before or beyond the patient interface device and defines a primary pressure-generating circuit.

During the course of conventional CPAP therapy, the patient may typically inhale only a fraction of the total flow of gas passing through the primary pressure-generating circuit. For example, it has been estimated that a CPAP gas flow of 8 L/min may typically result in a pharyngeal tube flow of about 2/L min. As a result, only 25% of aerosolized medicament introduced into the CPAP flow will enter the pharynx. In addition, from this 25% entering the pharynx, about two-thirds may be lost during expiration, assuming an inspiratory/expiratory ratio of 1:2. Thus, in conventional CPAP systems, only 10% of the nebulized drug may enter the patient interface device. This waste, particularly with extremely expensive surfactants, makes the cost of administering nebulized drugs through conventional CPAP systems unacceptably high for routine clinical use. To reduce these costs, the prior art has identified the need for improvements in the method of delivery for aerosolized drugs, e.g. it has been suggested that a method and apparatus are needed for restricting nebulization to inspiration only. See, for example, the article in Pediatric Pulmonology, supra.

It is therefore desirable to find ways to decrease the losses of aerosol particles within pressure-assisted breathing systems during the exhalation phase of the respiratory cycle. In particular, increasing the efficiency in the delivery of aerosolized medicaments through CPAP systems, and the resulting smaller amounts of medicament required for a treatment, can represent a substantial advantage, particularly when scarce and expensive medicaments are employed.

### BRIEF SUMMARY OF THE INVENTION

The present invention provides a pressure-assisted breathing system, e.g. a CPAP system, comprising in one embodiment a pressure-generating circuit for maintaining a positive pressure within the system, a patient interface device coupled to a patient's respiratory system, a respiratory circuit for providing gas communication between the pressure-generating circuit and the patient interface device, means for introducing aerosol particles, e.g. an aerosolized medicament, into the gas flow in the respiratory circuit and means for discontinuing the introduction of aerosol particles into the respiratory circuit when the patient exhales.

In one embodiment of the invention, the means for discontinuing the introduction of aerosol particles comprises a flow sensor disposed in an auxiliary circuit in fluid communication with the respiratory circuit and electronically coupled with the means for introducing the aerosol particles into the respiratory circuit flow. A small portion of the gas flow in the respiratory circuit is diverted through the flow sensor by the auxiliary circuit. Preferably the flow rate in the auxiliary circuit is adjusted to be commensurate with the middle of the flow rate range detected by the flow sensor. Preferred flow sensors are adapted to detect small changes in the volumetric flow rate of gas in the auxiliary circuit and send a corresponding electronic signal to the means for introducing aerosol particles into the respiratory circuit.

In one embodiment of the invention, the means for introducing aerosol particles comprises a nebulizer, most preferably, a nebulizer having a reservoir for holding a liquid medicament to be delivered to the patient's respiratory system, a vibrating aperture-type aerosol generator for aerosolizing the liquid medicament and a connector for connecting the nebulizer to the respiratory circuit so as to entrain the aerosolized medicament from the aerosol generator into the gas flowing through the respiratory circuit. As previously mentioned, the nebulizer is preferably electronically coupled to the flow sensor through the electronic circuitry of the CPAP system.

As with conventional CPAP operation, a constant flow of gas is maintained in the respiratory circuit by the CPAP system of the present invention during inhalation by the patient (hereinafter referred to as “inspiratory flow”). In the practice of the present invention, a flow corresponding to the inspiratory flow, but at a lesser flow rate, is diverted to the auxiliary circuit. An adjustable valve, e.g. an orifice valve, is preferably provided in the auxiliary circuit to regulate the flow of gas through the flow sensor. This valve may be used to reduce the flow of gas in the respiratory circuit to a range that can be measured by the flow sensor, and preferably in the middle of this range. Particularly preferred flow sensors have a flow range of from 0 to 1 liter/minute (“L/min”).

When the patient exhales, the flow of gas in the respiratory circuit (and correspondingly in the auxiliary circuit) increases as a result of the additional flow of gas generated by the patient's lungs (hereinafter referred to as “expiratory flow”). In a preferred embodiment, the flow sensor detects the change in the flow rate of gas in the auxiliary circuit corresponding to the expiratory flow in the respiratory circuit, and sends an electronic signal to turn off the aerosol generator of the nebulizer. When the expiratory flow ceases, the flow sensor detects the decrease in flow rate in the auxiliary circuit and discontinues the electronic signal to the nebulizer. As a result, the nebulizer turns on and resumes the introduction of aerosol particles into the respiratory circuit. In this way, the system of the present invention stops the delivery of aerosol particles during exhalation by the patient so that aerosol particles are introduced into the respiratory circuit only when the patient inhales.

A disposable filter is preferably positioned in the auxiliary circuit up-stream to the flow sensor. Since a portion of the expiratory flow is diverted into the auxiliary circuit, bacterial, viral or other contaminants emanating from the diseased patient's respiratory system may be present in the auxiliary circuit flow. The filter removes these contaminants before the air flow passes through the flow sensor and is preferably replaced with every new patient using the apparatus. This feature allows the flow sensor to be permanently connected to the electronic circuitry of the CPAP system and remain in place without contamination when the apparatus is used by different patients.

The present invention also provides a method of respiratory therapy wherein an aerosolized medicament is introduced into a pressure-assisted breathing system only when the patient inhales. In another embodiment, the invention provides a method of delivering an aerosol to a patient's respiratory system which comprises the steps of: (a) providing a pressure-assisted breathing system having a respiratory circuit wherein a constant inspiratory flow is provided to a patient during inhalation and an additional expiratory flow is generated by the patient during exhalation, (b) providing an auxiliary circuit to divert a portion of the total flow in the respiratory circuit to a flow sensor; (c) measuring the flow rate in the auxiliary circuit with the flow sensor when the total flow in the respiratory circuit comprises only the inspiratory flow, thereby producing a first electronic signal; (d) measuring the flow rate in the auxiliary circuit with the flow sensor when the total flow in the respiratory circuit comprises the sum of the inspiratory flow and the expiratory flow, thereby producing a second electronic signal; (e) providing a nebulizer electronically coupled to the flow sensor and adapted to introduce aerosol particles of medicament into the respiratory circuit when the first electronic signal is detected, and to stop the introduction of aerosol particles of medicament into the respiratory circuit when the second electronic signal is detected.

### BRIEF DESCRIPTION OF THE DRAWINGS

FIG. 1 is a schematic illustration of a CPAP system according to the present invention.

FIG. 2 is a cross-sectional view of the CPAP system of FIG. 1.

FIG. 3 is a schematic illustration of a CPAP system described in Example 2.

### DETAILED DESCRIPTION OF THE INVENTION

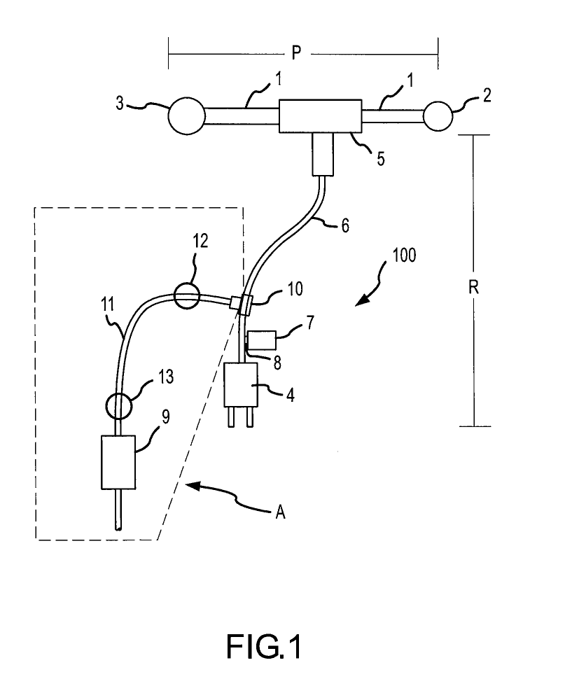

As shown in FIG. 1, one preferred embodiment of the invention comprises a CPAP system 100 having a primary pressure-generating circuit P, a respiratory circuit R and an auxiliary circuit A. The tubes associated with commercially available pressure-assisted breathing systems create a “circuit” for gas flow by maintaining fluid communication between the elements of the circuit. Tubes can be made of a variety of materials, including but not limited to various plastics, metals and composites and can be rigid or flexible. Tubes can be attached to various elements of the circuit in a detachable mode or a fixed mode using a variety of connectors, adapters, junction devices, etc. Circuit P includes a flow generator 2 in fluid communication through conduit 1 with a pressure-regulating device 3. One element is in “fluid communication” with another element when it is attached through a channel, port, tube or other conduit that permits the passage of gas, vapor and the like.

Respiratory circuit R includes a patient interface device, namely nasal cannula 4, which communicates with circuit P at “T”-shaped junction unit 5 through tube 6. Tube 6 is preferably a flexible tube having a smaller diameter than conduit 1, e.g. tube 6 may have an outside diameter of 5-8 mm or less. This arrangement allows the patient to move his/her head freely without disconnecting the patient interface device from the patient. Nebulizer 7 (comprising an aerosol generator) is in fluid communication with tube 6 at junction 8. Nebulizer 7 is adapted to emit an aerosolized medicament directly into the gas flow that is inhaled by the patient, i.e. the gas flow in respiratory circuit R, and is preferably located in the direct vicinity of the patient's nose, mouth or artificial airway (e.g. an endotracheal tube). Nebulizer 7 itself may comprise a built-in connector for connecting to tube 6 (as shown), or may be connected using a separate tube or connector.

Auxiliary circuit A includes flexible tube 11, preferably having the same outside diameter as tube 6, which connects flow sensor 9 with tube 6 at “T”-shaped junction unit 10. Junction unit 10 is preferably positioned close to nasal cannula 4, but upstream to nebulizer 7 so that aerosol particles emitted by nebulizer 7 are not diverted into tube 11. Adjustable orifice valve 12 may be positioned in tube 11 between junction 10 and flow sensor 9 to adjust the flow rate of gas passing through flow sensor 9, preferably to the middle of the optimal flow range for sensor 9. Disposable filter 13 may be positioned in tube 11 between junction 10 and flow sensor 9 to remove any bacterial, viral and/or other contaminants from the patient's diseased respiratory system that may be carried by the exhaled air passing through flow sensor 9.

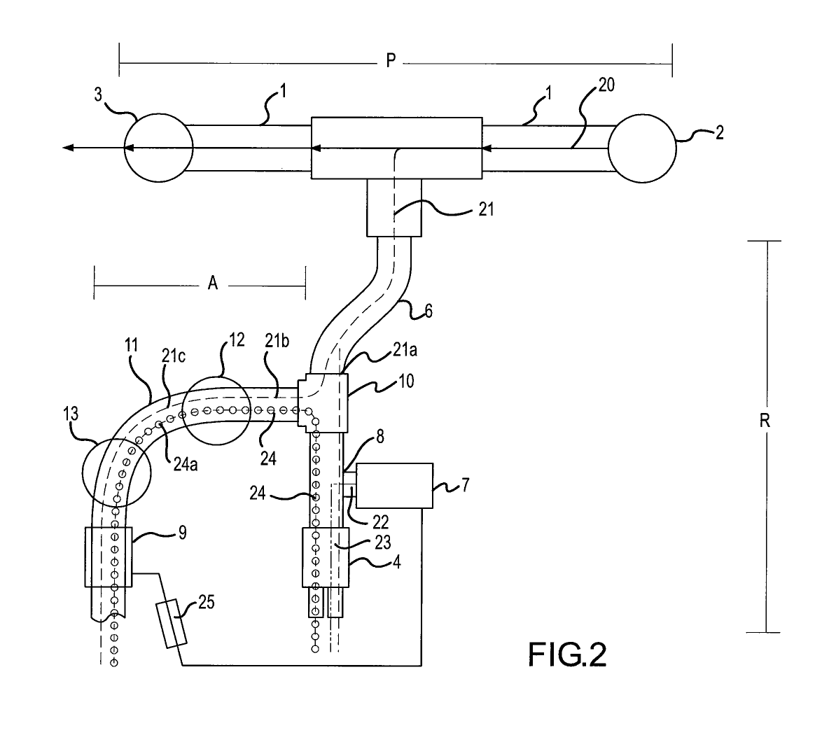

The operation of CPAP system 100 will be illustrated by referring to FIG. 2, which is an enlarged, cross-section view of CPAP system 100. A high volume flow of gas 20 is introduced into circuit P from flow generator 2 and passes through conduit 1 to pressure-regulating device 3 which maintains a continuous positive pressure throughout the system. Inspiratory flow 21, which may typically be about 10% of flow 20, flows from conduit 1 of pressure-generating circuit P into tube 6 of respiratory circuit R to provide a relatively constant inspiratory flow rate of air to the patient's respiratory system, thereby assisting in the patient's inspiratory efforts in accordance with conventional CPAP system principles. At junction 10, a portion 21a of inspiratory flow 21 proceeds through tube 6 to nasal cannula 4, and a portion 21b of inspiratory flow 21 is diverted through tube 11 to flow sensor 9.

Flow 21a passes through junction 8, at which point aerosolized medicament particles 22 produced by the aerosol generator of nebulizer 7 are introduced into flow 21a. Resulting flow 23 containing entrained aerosol particles 22 ultimately passes into the patient's respiratory system through nasal cannula 4, thereby delivering the aerosolized medicament to the patient's respiratory system. Flow 21b passes through tube 11 and adjustable orifice valve 12, which may be adjusted to reduce the rate of flow 21b to a reduced flow 21c, e.g. a flow rate that may be about 20% of the flow rate of flow 21b. Reduced flow 21c then proceeds through disposable filter 13 to flow sensor 9, and is ultimately released to the atmosphere. As flow 21c passes through flow sensor 9, flow sensor 9 measures the volumetric flow rate of flow 21c and generates a first electronic signal, e.g. a certain output voltage, in electronic circuitry 25 of CPAP system 100 that is characteristic of flow 21c. Since flow 21c is directly proportional to inspiratory flow 21, the first electronic signal caused by flow 21c may be used by the system to identify when the patient is inhaling and continue the delivery of aerosolized medicament.

When the patient exhales, expiratory flow 24 passes through nasal cannula 4 to tube 6 and is diverted through tube 11 at junction unit 10. Expiratory flow 24 is combined with inspiratory flow 21b in tube 11 to produce a flow rate equal to the sum of the flow rates of flow 24 and 21b. The combination of flow 24 and flow 21b passes through adjustable orifice valve 12 and the total flow rate is reduced in the same manner as previously described for flow 21b alone (identified in FIG. 2 as a combination of flow 21c and 24a). Disposable filter 13 removes any bacterial, viral or other contaminants that may have been present in the combined air flow as a result of flow 24a and the combined air flow then passes through flow sensor 9. When the combination of flow 21c and 24a passes through flow sensor 9, the change (increase) in flow rate over that of flow 21c alone is detected by flow sensor 9. As a result, flow sensor 9 generates a second electronic signal in electronic circuitry 25 that is different than the first electronic signal produced by flow 21c alone. The second electronic signal is transmitted by electronic circuitry 25 to nebulizer 7 and causes it to turn off its aerosol generator. This inactivation of the aerosol generator stops the introduction of aerosol particles 22 into flow 21a. Since the second electronic signal is generated by the volumetric flow rate of the combination of flow 21c and 24a, it indicates the presence of expiratory flow 24. Therefore, the second electronic signal may be used by the system to identify when the patient is exhaling and stop the introduction of aerosolized medicament. In this way, no aerosol is introduced into tube 6 when the patient exhales, and therefore, no aerosolized medicament is entrained in expiratory flow 24, which is ultimately released to the atmosphere and lost.

When expiratory effort by the patient stops and inhalation commences again, expiratory flow 24 discontinues and only inspiratory flow 21 is present in the system. As a result, only flow 21c passes through tube 11. Flow sensor 9 detects this change (decrease) in flow rate and generates the first electronic signal, which is transmitted to nebulizer 7. The first electronic signal causes nebulizer 7 to turn on the aerosol generator and resume the introduction of aerosol particles 22 into flow 21a. The turning on and off of the aerosol generator of nebulizer 7 in concert with the patient's respiratory cycle allows aerosolized medicament to be introduced into the CPAP system of the present invention only when the patient is inhaling. This results in a dramatic increase in the efficiency of delivery of the medicament and a corresponding reduction in losses of medicament to the atmosphere.

Flow generator 2 may conveniently comprise any of the known sources of pressurized gas suitable for use with pressure-assisted breathing systems such as CPAP systems. Typically, the flow generator is capable of supplying a flow of high-volume gas, which includes at least some portion of oxygen, at slightly greater than atmospheric pressure. For example, the source of pressurized gas may be an air blower or a ventilator, or the pressurized gas may originate from a wall supply of air and/or oxygen, such as that found within hospitals and medical facilities, or may originate from a pressurized cylinder or cylinders. The pressurized gas may comprise various known mixtures of oxygen with air, nitrogen, or other gases and may be provided in a single stream or flow to circuit R, for example, as shown by element 20 of FIG. 2.

Pressure-regulating device 3 may comprise any of the known devices for controlling and maintaining air pressure within a CPAP system at the desired constant level. Typically, pressure-regulating device 3 may comprise a restrictive air outlet device such as a pressure valve or threshold resistor that modulates the flow of gas leaving the pressure-regulating circuit P. In other applications, the modulation of the gas flow may be provided by releasing the air flow into a standardized vessel containing a predetermined quantity of water, with the pressure in the system being expressed in terms of the height to which the water rises in the vessel. Regardless of the pressure-regulating device used, the resistance to air flow in the pressure-generating circuit may be varied so that the continuous positive airway pressure conducted by respiratory circuit R to patient interface device 4 will suit the needs of the particular patient using the apparatus.

Although junction unit 5 may typically comprise a “T” or “Y”-shaped hollow unit (sometimes referred to as the “WYE”), it may take other shapes. As shown in FIG. 1, flexible tube 6 is connected to junction unit 5 and defines a branch gas conduit that depends from and is in gas communication with pressure-generating circuit P. Tube 6 is ultimately connected to a patient interface device, e.g. nasal cannula 4, to form respiratory circuit R. Flexible tube 6 is preferably relatively thin, smaller in diameter and more flexible than conduit 1 comprising pressure-generating circuit P. For example, flexible tube 6 may be commercially available silicone tubing having an outside diameter of about 5-8 mm.

The patient interface device 4 of the present invention may include any of the known devices for providing gas communication between the CPAP device and the patient's respiratory system. By way of example, the patient interface device may include nasal cannula or prongs (as shown in the Figures), an oral/nasal mask, a nasal mask, nasopharyngeal prongs, an endotracheal tube, a tracheotomy tube, a nasopharyngeal tube, and the like.

Nebulizer 7 may be any of the known devices for nebulizing (aerosolizing) drugs that are suitable for use with a CPAP system. Particularly preferred for the practice of this invention are those nebulizers having a vibrating aperture-type aerosol generator, for example, those nebulizers described in the present application's parent application and in U.S. Pat. Nos. 6,615,824; 5,164,740; 5,586,550; 5,758,637; and 6,085,740, and in copending U.S. patent application Ser. Nos. 10/465,023, filed Jun. 18, 2003, and 10/284,068, filed Oct. 30, 2002. The entire disclosures of said patents and applications are incorporated by reference herein. Particularly preferred nebulizers for the present invention are small and light-weight, for example having a net weight (without liquid) of 5 gms or less, preferably 3 gms or less, and have a connector adapted to attach to the weaker smaller diameter tube 6. Such “miniature” nebulizers may have a small reservoir that holds one unit dose of medicament, e.g. less than 4 ml of liquid, and a light-weight aerosol generator, e.g. on the order of about 1 gm in weight. In addition, preferred nebulizers are quiet in operation, e.g. producing less than 5 decibels of sound pressure, so that they can conveniently be placed very close to the patient.

The flow sensor 9 of the present invention may be a known flow sensor device that is adapted to detect small changes in the volumetric flow rate of fluid passing through it and is capable of generating an electronic signal, e.g. an output voltage, that is characteristic of that flow rate. A particularly preferred flow sensor for the practice of the present invention is commercially available from Omron Corporation of Japan, and is identified as “MEMS Flow Sensor, Model D6F-01A1-110”. The Omron flow sensor is capable of detecting a flow rate in the range of 0 to 1 L/min (at 0° C. and 101.3 kPa pressure). The relationship of measured flow rate and resulting output voltage for the Omron flow sensor is summarized in Table 1 below:

TABLE 1

| | Flow rate (L/min) | | | | | |
|---|---|---|---|---|---|---|
| | 0 | 0.2 | 0.4 | 0.6 | 0.8 | 1.0 |
| Output voltage (VDC ± 0.12) | 1.00 | 2.31 | 3.21 | 3.93 | 4.51 | 5.00 |

[Note: measurement conditions for Table 1 are as follows: power-supply voltage of 12 VDC, ambient temperature of 25° C. and ambient humidity of 25-75% RH.]

Nebulizer apparatus 7 may be connected to flow sensor 9 through the electronic circuitry 25 of the CPAP system. For example, nebulizer 7 may be connected to a controller (not shown) that turns the aerosol generator off and on in response to signals from flow sensor 9. Preferably, the controller and other electronic components of the CPAP system are connected with wires, cables and connectors that are small and flexible. Examples of other components that may also be associated with nebulizer apparatus 7 are a timer, status indication means, liquid medicament supply nebule or syringe, etc., all as known by those skilled in the art and described in detail in the aforementioned patent and patent applications.

The following examples will illustrate the present invention using the Omron flow sensor described above, but is not intended to limit the invention to the particular details set forth therein:

### EXAMPLE 1

A CPAP system of the present invention such as illustrated in FIGS. 1 and 2 may be used for respiratory treatment of an infant. The system may be pressurized to a pressure of 5 cm H₂O and a constant flow of air may be supplied by flow generator 2 into pressure-generating circuit P at a rate of 10 L/min. About 1 L/min (10%) of the air flow in pressure-generating circuit P may flow into flexible tube 6 as flow 21. During inhalation by the infant through nasal cannula 4, about 20% of flow 21 (identified in FIG. 2 as flow 21b) may be diverted into tube 11 at junction 10 by appropriately adjusting orifice valve 12 to produce a flow rate for flow 21c of about 0.2 L/min (0.2×1 L/min). Flow 21c may also pass through a disposable filter 13, but since flow 21c contains only inhalation air containing very little, if any, contamination, nothing significant should be removed from flow 21c by the filter. Flow 21c then may pass through the Omron flow sensor described above at a flow rate of 0.2 L/min, which according to Table 1 above, results in the generation of an output voltage of about 2.31 VDC. The electronic circuitry of the CPAP system may be configured to have the aerosol generator of nebulizer 7 turned on when the flow sensor is transmitting this output voltage to nebulizer 7. Turning on the aerosol generator introduces aerosolized medicament into the respiratory circuit R of the CPAP system so it can be inhaled by the infant.

During exhalation, the infant may exhale about 0.6 L/min of air flow through nasal cannula 4 to produce expiratory flow 24, which combines in tube 11 with flow 21b. As previously described for flow 21b alone, orifice valve 12 has been adjusted to reduce the flow rate of gas in tube 6 to about 20% of the original flow rate. Accordingly, flow 21b may be reduced to flow 21c having a flow rate of about 0.20 L/min (0.2×1 L/min) and flow 24 may be reduced to flow 24a having a flow rate of about 0.12 L/min (0.2×0.6 L/min). The combined expiratory flow rate of the combination of flow 21c and 24a therefore equals about 0.32 L/min. This combined expiratory flow rate may then pass through disposable filter 13 to remove any contaminates that may be present as a result of expiratory flow 24a, and then pass through the Omron flow sensor. Again referring to Table 1 above, it can be seen that the Omron pressure sensor generates an output voltage of about 3.0 VDC at the combined exhalation flow rate of 0.32 L/min. The electronic circuitry of the CPAP system may be configured to have the aerosol generator of nebulizer 7 turned off when this output voltage is transmitted to nebulizer 7 by electronic circuitry 25. Turning off the aerosol generator ceases the introduction of aerosolized medicament particles 22 into the respiratory circuit R of the CPAP system during the presence of expiratory flow 24. As a result, a minimum amount of aerosol is entrained in expiratory flow 24 and ultimately lost to the atmosphere. In some cases, electronic circuitry 25 may include a phase shift circuit which can slightly advance or delay the inactivation of the aerosol generator, if desired.

When the flow rate through the Omron flow sensor returns to 0.2 L/min during inhalation, the output voltage of the Omron flow sensor returns to 2.31 VDC. Since this voltage is characteristic of the inhalation phase of the patient's respiratory cycle, it may be used by electronic circuitry 25 as a signal to turn on the aerosol generator again so that the introduction of aerosolized medicament into the respiratory circuit of the CPAP system is resumed during inhalation. The cycle of turning the nebulizer on and off depending on what phase of the patient's respiratory cycle is occurring may be repeated during the period that the CPAP system is used for respiratory treatment of the infant, thereby significantly reducing the amount of medicament needed for such treatment.

### EXAMPLE 2

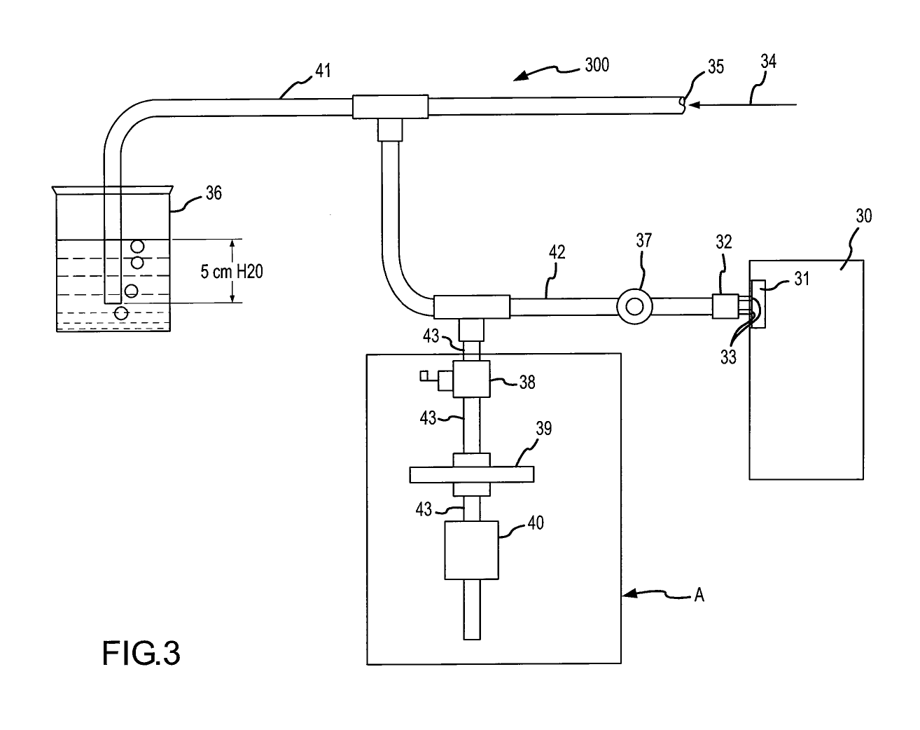

Referring to FIG. 3, CPAP system 300 was attached to a breathing simulation piston pump 30 (commercially available from Harvard Apparatus, Holliston, Mass. 01746) to simulate an infant's breathing cycle. CPAP system 300 included auxiliary circuit A comprising pressure valve 38, disposable filter 39 and flow sensor 40 connected to respiratory circuit 42 through tube 43 in accordance with the present invention. A removable filter 31 was placed at the inlet of pump 30. An adapter 32 with two orifices 33 representing infant nares (Argyle nasal prong commercially available from Sherwood Medical, St. Louis, Mo. 63013) was connected to filter 31. Nebulizer 37 (Aeroneb® Professional Nebulizer System commercially available from Aerogen, Inc., Mountain View, Calif.) was placed in respiratory circuit 42 near adapter 32 so as to deliver an aerosolized drug into the air flow passing through orifices 33. During the operation of pump 30, air containing the entrained aerosolized drug flowed back and forth through filter 31, which collected the drug from the air flow. The amount of drug collected on filter 31 after each test was measured by high-pressure liquid chromatography (HPLC) and compared to the total amount that was nebulized to provide a measure of the efficiency of aerosol delivery to the system.

Pump 30 was set to infant ventilatory parameters with a tidal volume of 10 ml and a respiratory rate of 40 breaths per minute. A constant air flow 34 of 10 L/min was provided through CPAP inlet 35 and resistance pressure regulator 36 was set to generate a pressure of 5 cm H₂O. Nebulizer 37 was filled with 3 ml of a solution of albuterol sulfate (“albuterol”). In order to study the effect of synchronized nebulization (i.e., nebulization during inhalation only) versus continuous nebulization, two separate sets of 4 tests were conducted. In the first set of tests, nebulizer 37 ran continuously during both the inhalation and exhalation cycles of pump 30. In the second set of tests, the operation of nebulizer 37 was stopped during the exhalation cycle of pump 30 using the input from flow sensor 40 in accordance with the present invention. After each test, the amount of albuterol collected on filter 31 was measured by HPLC and compared with the amount of albuterol nebulized to obtain a percent efficiency. The results are summarized in Table 2 below:

TABLE 2

| | |
|---|---|
| Test No. | Efficiency |

Continuous Nebulization:

| | |
|---|---|
| 1 | 26% |
| 2 | 24% |
| 3 | 22% |
| 4 | 27% |
| Average Efficiency: | 24.75% |

Synchronized Nebulization:

| | |
|---|---|
| 1 | 40% |
| 2 | 44% |
| 3 | 51% |
| 4 | 43% |
| Average Efficiency: | 44.5% |

The above results demonstrate that synchronized nebulization according to the present invention may deliver an order of magnitude more albuterol through nasal prongs during CPAP than continuous nebulization.

The high efficiency of delivery of aerosolized medicaments according to the present invention is particularly valuable in respiratory therapies that utilize expensive or scarce medicaments, such as the aforementioned NCPAP treatment of iRDS using aerosolized surfactants. Since most surfactants are animal-based, the current supply is limited, and although synthetic surfactants are available, their manufacture is both inexact and expensive. In addition, the surfactant medicaments are typically high in viscosity and are difficult to deliver to the patient's respiratory system. The increased efficiency of the pressure-assisted breathing system of the present invention, and the smaller amount of medicament required for a treatment according to the present invention, can be a substantial advantage when such scarce and expensive medicaments are employed.

It is understood that while the invention has been described above in connection with preferred specific embodiments, the description and drawings are intended to illustrate and not limit the scope of the invention, which is defined by the appended claims and their equivalents.

1-22. (canceled)

23. A pressure-assisted breathing system comprising:
a patient interface device adapted to be coupled to a patient's respiratory system;
a pressure-generating circuit having a gas flow of sufficiently high volume to provide positive pressure to the patient's respiratory system through the patient interface device;
and
a nebulizer in gas communication with the patient interface device and positioned to deliver aerosol particles to the patient interface device outside the high-volume gas flow in the pressure-generating circuit.

24. A pressure-assisted breathing system according to claim 23 wherein the nebulizer is positioned to introduce aerosol particles into a respiratory circuit providing gas communication between the pressure-generating circuit and the patient interface device, whereby inhalation by the patient through the patient interface device produces a second gas flow in the respiratory circuit that is of lower volume than the gas flow in the pressure-generating circuit.

25. A pressure-assisted breathing system according to claim 24 wherein the pressure-generating circuit comprises a first conduit that conducts the high-volume gas flow from a flow generator to a pressure-regulating device, and the respiratory circuit comprises a second conduit having one end connected to the first conduit at a location between the flow generator and the pressure-regulating device and the opposite end directly connected to the patient interface device.

26. A pressure-assisted breathing system according to claim 23 wherein the nebulizer is located in the direct vicinity of the patient's nose, mouth or artificial airway.

27. A nebulizer apparatus comprising:
a light-weight, miniature nebulizer, comprising a reservoir for holding a single dose of liquid medicament to be delivered to a patient's respiratory system and a vibrating aperture-type aerosol generator for aerosolizing the liquid medicament; and
a connector adapted to connect the nebulizer to a pressure-assisted breathing system having a pressure-generating circuit, wherein the connector is further adapted to connect to the pressure-assisted breathing system at a location outside the pressure-generating circuit.

28. A nebulizer apparatus according to claim 27 wherein the pressure-generating circuit of the pressure-assisted breathing system comprises a first type of flexible tubing that has a diameter and flexibility suitable for carrying the high volume gas flow, and the connector is configured to attach to a second type of flexible tubing that is smaller in diameter and more flexible than the first type of tubing.

29. A nebulizer apparatus according to claim 27 wherein the reservoir has a capacity of 4 ml or less.

30. A nebulizer apparatus according to claim 27 wherein the nebulizer produces 5 decibels or less of sound.

31. A nebulizer apparatus according to claim 27 wherein the aerosol generator of the nebulizer has a weight of less than about 5 gms.

32. A junction device for connecting an inspiratory limb and an expiratory limb of a pressure-assisted breathing system to a patient interface device, said junction device comprising:
a tubular main body member having a substantially straight longitudinal lumen extending its entire length for conducting a first flow of pressurized gas carrying aerosol particles from a first tube attached to one end of the longitudinal lumen to a second tube attached to the opposite end of the longitudinal lumen, wherein the first tube comprises the inspiratory limb and the second tube comprises a respiratory circuit connected to the patient interface device;
a tubular branch member in fluid communication with the longitudinal lumen at one end of the branch member and attached to a third tube comprising the expiratory limb at the opposite end of the branch member for conducting a second flow of gas substantially free of said aerosol particles into or out of the longitudinal lumen;
a nebulizer port for attaching a nebulizer to the main body member so as to introduce said aerosol particles into the first flow of gas; and
a vibrating aperture-type nebulizer having a vibrating aperture plate positioned completely within the nebulizer port and in close proximity to, but not extending through the longitudinal lumen so as avoid any protrusion into the longitudinal lumen that would cause turbulence in the first flow of gas and the resulting deposition of aerosol particles on said internal surface wall.

33. A ventilator system comprising:
an inspiratory tube and an expiratory tube joined together to form a ventilator circuit;
a respiratory tube connecting the ventilator circuit to a patient interface device to form a respiratory circuit;
at least one or both of a first and second nebulizer, the first nebulizer positioned in the respiratory circuit and the second nebulizer positioned in the ventilator circuit.

34. A ventilator system according to claim 33 wherein the ventilator circuit is connected to the patient interface device by a connector comprising an arcuate path for aerosol particles coming through the respiratory circuit from the second nebulizer to the patient interface device, thereby minimizing loss of aerosol particles from the impact of the aerosol particles on the walls of the connector.

35. A ventilator system according to claim 34 wherein the first nebulizer is positioned in close proximity to the patient interface device.

36. A method of delivering an aerosol to a patient's respiratory system comprising the steps of:
generating a first gas flow in a first conduit that connects a gas flow generator to a pressure-regulating device;
connecting one end of a second conduit to the first conduit and the opposite end of the second conduit to a patient interface device so that inhalation by the patient draws a second gas flow from the first gas flow into the patient's respiratory system; and
introducing aerosol particles into the second gas flow and thereby into the patient's respiratory system.

37. A method of increasing the amount of aerosol particles delivered to a patient's respiratory system through one or more circuits of a pressure-assisted breathing system wherein at least one circuit has a gas flow of sufficiently high volume to provide positive pressure to the patient's respiratory system through a patient interface device, comprising the step of introducing the aerosol particles into the system at a point outside the high volume gas flow to avoid dilution of the aerosol particles.

38. A method of increasing the amount of aerosol particles delivered to a patient's respiratory system through one or more circuits of a pressure-assisted breathing system, comprising the step of eliminating any sharp angles or corners encountered by the flow of aerosol particles in said circuits.

39. A method according to claim 38 wherein the sharp angles are eliminated by providing a straight or gently angled path for the flow of aerosol particles from the point at which the aerosol particles are introduced into a circuit of the pressure-assisted breathing system to the point at which the aerosol particles enter the patient's respiratory system.

40. A method according to claim 39 wherein the gently angled path comprises a change in angle no greater than 15°.
